(19) United States
(12) Patent Application Publication
(10) Pub. No.: US 2014/0311834 A1
(43) Pub. Date: Oct. 23, 2014

(54) FALL ARREST DEVICE

(71) Applicant: The Heightec Group Limited, Kendal (GB)

(72) Inventors: Ian Christopher Lawton, Kendal (GB); Keith Jones, Windermere (GB); George Sewell, Kendal (GB)

(73) Assignee: The Heightec Group Limited, Kendal (GB)

(21) Appl. No.: 14/259,562

(22) Filed: Apr. 23, 2014

(30) Foreign Application Priority Data
Apr. 23, 2013 (GB) 1307322.6

(51) Int. Cl. A62B 1/14; E04G 21/32; A62B 35/00

(52) U.S. Cl. CPC A62B 1/14; A62B 35/0081; E04G 21/3204
USPC 188/65.2

(57) ABSTRACT

A fall arrest device comprising a body having a rope guide path therethrough defined between a cam and a cooperating abutment. The cam is pivotally mounted on the body about a pivot axis extending perpendicular to the rope guide path. The device is provided with an attachment means for attaching the device to a harness, a rope jamming portion of the cam being arranged to be urged towards the abutment to a rope jamming position to arrest movement of the rope through the rope guide path under the action of a load applied to the attachment means. A rope engaging surface of the rope guide path remote from said rope jamming portion of the cam is adapted to grip the rope when the rope acts thereagainst by virtue of a downward load applied to the attachment means.

This invention relates to a fall arrest device arresting the descent of a person or other load down a rope, lifeline, cable, web or other similar elongate load supporting member or line (collectively referred to hereinafter as “rope”), and in particular to a fall arrest device for use for arresting the descent of a person down a rope in the event of a fall.

When working at height it is typical for a person to use a fall arrest device being coupled to a rope, whereby the device is adapted to automatically lock onto the rope in the event of a fall.

Such fall arrest devices connect to the safety harness of the user, typically via a lanyard, and travel up and down the rope, engaging the rope when the force applied to them via the harness exceeds a predetermined threshold (i.e. when the user slips or falls). Such devices commonly contain a cam pivotally mounted on the body of the device at a point along its length and a cooperating abutment with the rope passing therebetween. When a load is applied to the body of said device the rope comes into operative contact with the distal end of the cam, urging the proximal end of the cam toward the abutment, thereby engaging the rope therebetween. Some known devices incorporate a groove in said distal end of the cam, the groove acting as a guide to keep the rope in contact with the cam by preventing it from passing around the side. Said grooves are characterised by being wider than they are deep and similarly wider than the diameter of the rope to allow the rope to slide smoothly within the groove.

The inherent problem with these devices is that all of the engaging force when the device is activated in the event of a fall is transmitted to the rope via the proximal end of the cam and the cooperating abutment. When high loads are transmitted to the rope or the rope is worn or degraded, this force can lead to rupture of some or all of the rope fibres at the engaging point.

The invention seeks to overcome these problems by providing a fall arrest device that engages the rope at at least two separate points by two separate actions.

According to the present invention there is provided a fall arrest device comprising a body having a rope guide path therethrough defined between a cam and a cooperating abutment, said cam being pivotally mounted on said body about a pivot axis extending perpendicular to said rope guide path, said device being provided with an attachment means for attaching the device to a harness, a rope jamming portion of the cam being arranged to be urged towards the abutment to a rope jamming position to arrest movement of the rope through the rope guide path under the action of a load applied to the attachment means, wherein a rope engaging surface of the rope guide path remote from said rope jamming portion of the cam is adapted to grip the rope when the rope acts thereagainst by virtue of a downward load applied to the attachment means.

Said rope engaging surface may comprise a groove or channel within which the rope is received, the sides of the groove or channel being shaped and/or dimensioned to trap or squeeze the rope therein, preferably between opposite sides of the groove or channel, when a downward load is applied to the attachment means.

Preferably said groove or channel has a V shaped profile. Preferably opposite sides of the groove or channel define an acute angle therebetween.

Preferably the sides of said groove or channel diverge outwardly from a base region thereof. The width of the base of the groove is preferably less that the diameter of the rope.

Preferably said groove or channel extends along at least a portion of a rope engaging surface of the cam. Alternatively, or additionally, the groove or channel may extend along a least a portion or a rope engaging surface of the abutment. Preferably the depth of said groove or channel increases in a direction away from said rope jamming portion of the cam.

In one embodiment the attachment means is located on the body of the device to one side of the rope guide path such that the action of a load applied to the attachment means causes rotation of the body, said rotation causing the rope to act against a distal end of the cam such that a proximal end of the cam is biased towards the abutment into said rope jamming position to arrest movement of the rope through the rope guide path, at least a portion of said rope engaging surface being provided on said distal end of the cam, said rope engaging surface being adapted to grip the rope when the rope acts against said distal end of the cam as the body of the device is rotated by virtue of a load applied to the attachment means. Preferably the cam is provided on a side of the rope guide path opposite said attachment means, said proximal end of the cam comprising a lower end thereof and said distal end comprising an upper end thereof.

The attachment means may comprise one or more apertures provided in the body of the device for receiving a karabiner, screw-link or similar attachment device.

The body of the device may comprise a base plate, upon which the cam and abutment are mounted, and a cover plate, mounted parallel to the base plate, the cover plate being pivotally moveable between a rope loading/removing position and a closed position to allow a rope to inserted and then retained within the device in said rope guide path defined between the cam and abutment, said attachment means comprising cooperating apertures formed in the base plate and cover plate, said apertures being aligned with one another when the cover plate is in its closed position, wherein the aperture of the cover plate extends to one side of the cover plate to define an open side thereof, said open side being closed by a latch or closure member, whereby said latch or closure member may be displaced to an open position to allow the cover plate to be moved to its rope loading/removing position from its closed position while a connector is attached to said apertures.

An embodiment of the present invention will now be described, by way of example only, with reference to the accompanying drawings, in which:

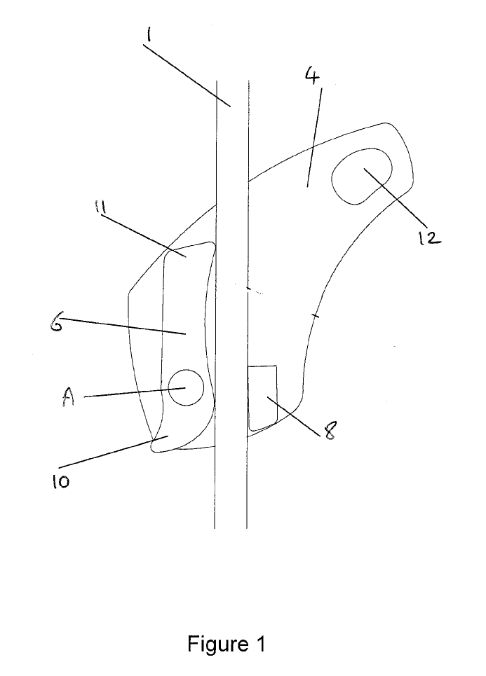

FIG. 1 is a front view of a fall arrest device in accordance with a first embodiment of the present invention with a second support plate removed for clarity;

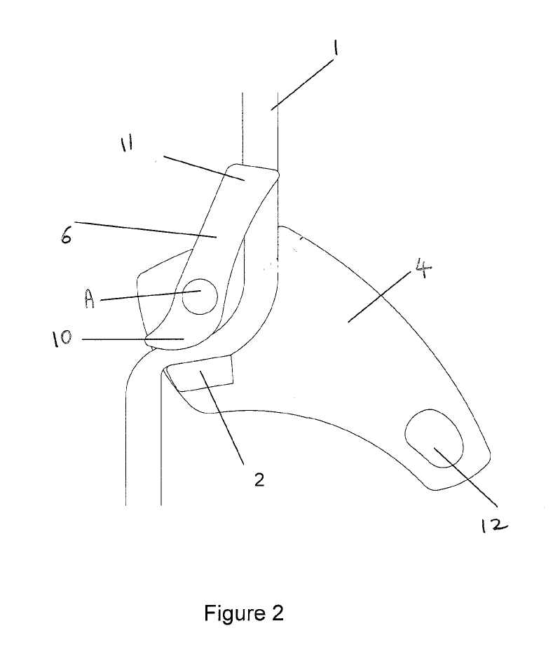

FIG. 2 is a front view of the fall arrest device of FIG. 1 in an arrest configuration;

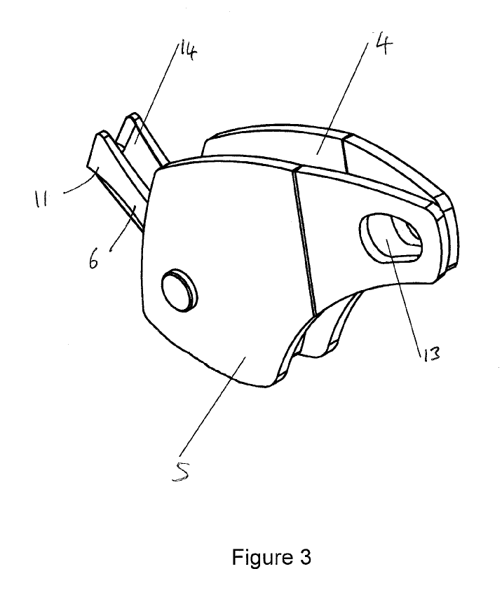

FIG. 3 is a perspective view of the fall arrest device of FIG. 1; and

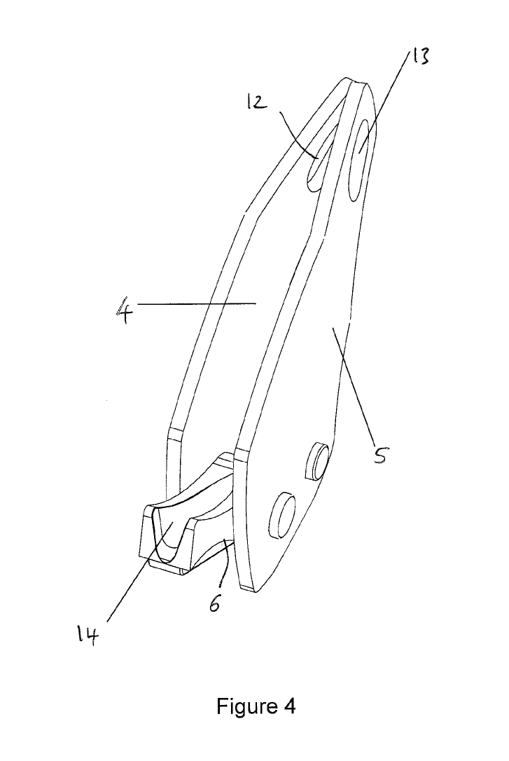

FIG. 4 is a further perspective view of the fall arrest device of FIG. 1.

A fall arrest device 2 in accordance with an embodiment of the present invention is illustrated in FIGS. 1 to 4.

As illustrated in FIG. 1, the device 2 comprises a body comprising a base plate 4 and a cover plate 5 (omitted for clarity in FIGS. 1 and 2) mounted parallel to the base plate 4, the cover plate 5 being pivotally movable between a rope loading/removing position and a closed position to allow a rope, such as a lifeline 1 or secondary line, to be inserted and then retained in the device 2 in a rope guide path defined between opposed guide surfaces of a moveable cam 6 and a fixed abutment 8.

The cam 6 is mounted on a first side of the rope guide path and the abutment 8 is mounted on a second side of the rope guide path. The cam 6 is pivotally mounted on the body of the device for pivotal movement about a pivot axis “A” extending perpendicular to the base plate 4 and perpendicular to the rope guide path. A lower end 10 of the cam 6, proximal the abutment 8, is moveable to a jamming position wherein the lifeline is jammed between the lower end 10 of the cam 6 and the abutment 8 when the lifeline acts against the upper or distal end 11 of the cam 6, as will be described in more detail below. A spring may be provided for biasing the cam 6 away from or towards its jamming position.

As best illustrated in FIGS. 3 and 4, a V shaped groove 14 is formed in the upper or distal end 11 of the cam such that the groove 14 defines a portion of the rope guide path, said groove 14 having opposite sides diverging outwardly at an acute angle to one another. A base region of the groove 14 has a width narrower than the diameter of the lifeline 1, such that the sides of the groove can grip the lifeline 1 when the lifeline is pulled down into the groove 14, as will be described below in more detail. The groove 14 may extend from the upper or distal end 11 of the cam 6 to a position at or adjacent the lower end 10 of the cam 8, the depth of the groove 14 gradually reducing from the upper end 11 of the cam towards the lower end 10.

Aligned apertures 12, 13 are provided in the base plate 4 and cover plate 5 to define an attachment means for connecting the device 2 to a harness, typically via a lanyard attached to the harness of a user of the device 2, via a suitable connector, such as a karabiner or screw-link. The attachment of a connector to the attachment apertures may also serve to secure the cover plate 5 in its closed position. The attachment apertures 12, 13 are located on said second side of the rope guide path behind the lifeline 1. It is also envisaged that the aperture 13 provided in the cover plate 5 may extend to one side of the cover plate and may be provided with a catch or closure at an open side thereof to allow the cover plate 5 may be moved to its open position, enabling a rope to be inserted into or removed from the rope guide path, without detaching the device 2 from the harness of the user.

The fall arrest device 2 may be used as a general purpose fall arrest device for persons 25 working at height or as a back up device on a lifeline to arrest the fall of a person should the working equipment, such as an ascender or descender, attached to a working line fail.

In use, the cover plate 5 is moved to its open position and the rope 1 is inserted into the rope guide path between said rope guide surfaces of the cam 6 and abutment 8. The cover plate 5 is then moved to its closed position to retain the device on the rope 1. The device 2 may be attached to a user's harness by attaching a suitable connector, such as a karabiner or screw-link to the attachment apertures 12, 13, said connector typically being provided at a distal end of a lanyard attached to the harness or being mounted directly on the harness.

In the event of a fall, the position at which the resulting load from the harness is applied to the body of the device creates a moment about the rope guide path, changing the angle of the device 2 with respect to the rope 1 and causing the rope 1 to be pulled down into the groove 14 in the upper end 11 of the cam 6, increasing the frictional forces applied to the rope 1 by the sides of the groove and causing the sides of the groove 14 to grip the rope 1, providing a restraining force against the movement of the rope 1 through the groove 14. At the same time, the action of the rope against the upper end 11 of the cam 6 urges the lower end 10 of the cam 6 towards the abutment 8 into its jamming position, arresting movement of the rope 1 through the rope guide path, thus retaining the user suspended from the rope 1 by the device 2.

Thus the device 2 overcomes the problem associated with prior art fall arrest devices by spreading the arresting force applied to a rope over a section of the rope, by virtue of the restraining force generated by the groove 14, rather than concentrating the force at one point on the rope.

In an alternative mode of use, the device 2 may be attached to an anchor point via the attachment apertures 12, 13 and a load may be applied to a lower end of a rope passing through the rope guide path of the device.

The invention is not limited to the embodiment(s) described herein but can be amended or modified without departing from the scope of the present invention.

1. A fall arrest device comprising:
a body having a cam and a cooperating abutment attached thereto, with a rope guide path defined between the cam and the cooperating abutment;
the cam being pivotally mounted on the body about a pivot axis extending perpendicular to the rope guide path;
an attachment portion for attaching the device to a harness;
the cam comprising a rope jamming portion that is arranged to be urged towards the abutment to a rope jamming position, wherein the cam is operable to arrest movement of the rope through the rope guide path under the action of a load applied to the attachment portion; and
a rope engaging surface disposed along the rope guide path remote from the rope jamming portion of the cam, wherein the rope engaging surface is configured to grip the rope when the rope acts thereagainst by virtue of a downward load applied to the attachment portion.

2. A device as claimed in claim 1, wherein the rope engaging surface comprises a groove or channel within which the rope is received, and wherein sides of the groove or channel are shaped and/or dimensioned to trap or squeeze the rope therein when a downward load is applied to the attachment portion.

3. A device as claimed in claim 2, wherein the groove or channel has a V shaped profile.

4. A device as claimed in claim 3, wherein opposite sides of the groove or channel define an acute angle therebetween.

5. A device as claimed in claim 2, wherein the sides of the groove or channel diverge outwardly from a base region thereof.

6. A device as claimed in claim 5, wherein the width of the base region of the groove is less than the diameter of the rope.

7. A device as claimed in claim 2, wherein the cam comprises the rope engaging surface and the groove or channel extends along at least a portion of the rope engaging surface.

8. A device as claimed in claim 7, wherein the depth of the groove or channel increases in a direction away from the rope jamming portion of the cam.

9. A device as claimed in claim 1, wherein the attachment portion is located on the body of the device to one side of the rope guide path, such that the action of a load applied to the attachment portion causes rotation of the body, the rotation causing the rope to act against a distal end of the cam such that a proximal end of the cam is biased towards the abutment into the rope jamming position to arrest movement of the rope through the rope guide path, at least a portion of the rope engaging surface being provided on the distal end of the cam, the rope engaging surface being adapted to grip the rope when the rope acts against the distal end of the cam as the body of the device is rotated by virtue of a load applied to the attachment portion.

10. A device as claimed in claim 9, wherein the cam is provided on a side of the rope guide path opposite the attachment portion, the proximal end of the cam comprising a lower end thereof and the distal end comprising an upper end thereof.

11. A device as claimed in claim 1, wherein the body of the device comprises a base plate, upon which the cam and abutment are mounted, and a cover plate, mounted parallel to the base plate, the cover plate being pivotally moveable between a rope loading/removing position and a closed position to allow a rope to inserted and then retained within the device in the rope guide path defined between the cam and abutment, the attachment portion comprising cooperating apertures formed in the base plate and the cover plate, the apertures being aligned with one another when the cover plate is in its closed position, wherein the aperture of the cover plate extends to one side of the cover plate to define an open side thereof, the open side being closed by a latch or closure member, whereby the latch or closure member is displaceable to an open position to allow the cover plate to be moved to its rope loading/removing position from its closed position while a connector is attached to the apertures.

12. (canceled)

13. A device as claimed in claim 10, wherein the body of the device comprises a base plate, upon which the cam and abutment are mounted, and a cover plate, mounted parallel to the base plate, the cover plate being pivotally moveable between a rope loading/removing position and a closed position to allow a rope to inserted and then retained within the device in the rope guide path defined between the cam and abutment, the attachment portion comprising cooperating apertures formed in the base plate and the cover plate, the apertures being aligned with one another when the cover plate is in its closed position, wherein the aperture of the cover plate extends to one side of the cover plate to define an open side thereof, the open side being closed by a latch or closure member, whereby the latch or closure member is displaceable to an open position to allow the cover plate to be moved to its rope loading/removing position from its closed position while a connector is attached to the apertures.
